(19) United States
(12) Patent Application Publication
(10) Pub. No.: US 2026/0277577 A1
(43) Pub. Date: Sep. 17, 2026

(54) PROCESSING METHOD

(71) Applicant: Bytedance Technology Ltd., Grand Cayman (KY)

(72) Inventors: Yilei Wang, Beijing (CN); Xuewu Huang, Beijing (CN); Yuting Bian, Beijing (CN); Ye Li, Beijing (CN); Yuwei Wang, Beijing (CN); Yunkai Zhu, Beijing (CN); Runshan Wang, Beijing (CN)

(21) Appl. No.: 19/247,972

(22) Filed: Jun. 24, 2025

(30) Foreign Application Priority Data
Mar. 13, 2025 (CN) 202510299791.0

(51) Int. Cl. G06F 8/61

(52) U.S. Cl. CPC G06F 8/61

(57) ABSTRACT

The application discloses a processing method, apparatus, device, medium and product. In an example, an application package of a target application is obtained by storing some resource packages in a native resource directory after being compressed. By decompressing and installing currently needed compression results stored in the native resource directory, the dynamic on-demand installation of resources for the target application can be achieved subsequently following a system configuration of an electronic device.

### CROSS-REFERENCE

This application claims priority to Chinese Patent Application No. 202510299791.0 entitled “PROCESSING METHOD, APPARATUS, DEVICE, MEDIUM AND PRODUCT” filed on Mar. 13, 2025, the entirety of which is incorporated herein by reference.

### FIELD

The present application relates to the field of computer technologies, and in particular, to a processing method.

### BACKGROUND

With the popularization of electronic devices, users can download and install some applications (Apps) meeting their needs in electronic devices used by users, so that these Apps can provide the users with corresponding services (such as short video services, instant messaging services, live streaming services, etc.).

However, in some scenarios, because only a resource adapted to a configuration (e.g., a system language is English configuration) is integrated in an App, the App is only suitable for serving a part of users (such as English users), and is not suitable for providing services for other users (such as a Chinese user), which affects user experience.

### SUMMARY

The present application provides a processing method, apparatus, device, medium and product, which are beneficial to improving user experience.

To achieve the above objective, technical solutions provided in the present application are as follows.

The present application provides a processing method, which is applied to an electronic device, and the method includes: obtaining an application package of a target application for installation, where the application package includes a native resource directory and a running resource directory, the native resource directory stores compression results of a plurality of resource packages in a target dimension, different resource packages are adapted to different configurations in the target dimension, and the running resource directory indicates an installed resource file; obtaining a configuration parameter of the electronic device in the target dimension in response to a start request of the target application; and decompressing and installing a compression result of a resource package adapted to the configuration parameter and updating the running resource directory in response to the running resource directory indicating that the resource package adapted to the configuration parameter is not installed and the compression result of the resource package adapted to the configuration parameter is stored in the native resource directory, the updated running resource directory indicating that the resource package adapted to the configuration parameter has been installed.

In a possible implementation, the start request indicates starting the target application for the first time.

In a possible implementation, the application package further includes a supplementary resource directory, and the supplementary resource directory indicates a storage path of decompression results for respective compression results; and decompressing and installing the compression result of the resource package adapted to the configuration parameter includes: decompressing the compression result of the resource package adapted to the configuration parameter to the supplementary resource directory for installation.

In a possible implementation, a process of building the application package of the target application includes: dismantling a post file of the target application into a plurality of application packages, where the plurality of application packages include a basic package and the plurality of resource packages; and building the application package of the target application based on the compression results of respective resource packages in the plurality of resource packages and the basic package, where the running resource directory in the application package of the target application indicates that an installation process of the application package of the target application includes installing the basic package.

In a possible implementation, the plurality of application packages further include one or more default resource packages in the target dimension, and a configuration adapted to the default resource package in the target dimension is different from a configuration adapted to respective resource packages of the plurality of resource packages in the target dimension; and building the application package of the target application based on the compression results of respective resource packages in the plurality of resource packages and the basic package includes: building the application package of the target application based on the compression results of respective resource packages in the plurality of resource packages, the default resource package and the basic package, where the running resource directory in the application package of the target application indicates that the installation process of the application package of the target application further includes installing the default resource package.

In a possible implementation, a number of the default resource packages is determined based on at least one of: a size constraint of the application package of the target application or a running constraint of the target application on the electronic device, the size constraint indicates a maximum size of the application package of the target application, and the running constraint indicates at least one of: a maximum time consumption or a maximum success rate of running the target application according to the configuration parameter of the electronic device in the target dimension.

In a possible implementation, a compression algorithm for respective resource packages of the plurality of resource packages is determined based on at least one of: a size of the post file, a size constraint of the application package of the target application, or a running constraint of the target application on the electronic device, the size constraint indicates a maximum size of the application package of the target application, and the running constraint indicates at least one of: a maximum time consumption or a maximum success rate of running the target application according to the configuration parameter of the electronic device in the target dimension.

In a possible implementation, the method further includes: loading the resource package adapted to the configuration parameter in response to the running resource directory indicating that the resource package adapted to the configuration parameter has been installed.

In a possible implementation, the method further includes: obtaining, from a server, the resource package adapted to the configuration parameter for installation in response to the running resource directory indicating that the resource package adapted to the configuration parameter is not installed and the compression result of the resource package adapted to the configuration parameter is not stored in the native resource directory, where the server provides at least one resource package in the target dimension to the target application, and a usage probability of a resource package obtained from the server is less than a usage probability of a resource package obtained from the native resource directory.

In a possible implementation, the method further includes: obtaining a target configuration indicated by a configuration switching request in response to the configuration switching request in the target dimension; in response to the running resource directory indicating that a resource package adapted to the target configuration is not installed and a compression result of the resource package adapted to the target configuration is stored in the native resource directory, decompressing the compression result of the resource package adapted to the target configuration; restarting the target application; installing the resource package adapted to the target configuration obtained through decompression; and updating the running resource directory, the updated running resource directory indicating that the resource package adapted to the target configuration has been installed.

In a possible implementation, the target dimension includes a language type.

The present application provides a processing apparatus, which includes: a first processing unit, configured to obtain an application package of a target application for installation, where the application package includes a native resource directory and a running resource directory, the native resource directory stores compression results of a plurality of resource packages in a target dimension, different resource packages are adapted to different configurations in the target dimension, and the running resource directory indicates an installed resource file; a second processing unit, configured to obtain a configuration parameter of the electronic device in the target dimension in response to a start request of the target application; and a third processing unit, configured to, in response to decompress and install a compression result of a resource package adapted to the configuration parameter and update the running resource directory in response to the running resource directory indicating that the resource package adapted to the configuration parameter is not installed and the compression result of the resource package adapted to the configuration parameter is stored in the native resource directory, the updated running resource directory indicating that the resource package adapted to the configuration parameter has been installed.

The present application provides an electronic device, including a processor and a memory, where the memory is configured to store instructions or a computer program, and the processor is configured to execute the instructions or the computer program in the memory to cause the electronic device to perform the processing method provided in the present application.

The present application provides a computer readable medium, where the computer readable medium stores instructions or a computer program, and when the instructions or the computer program runs on a device, the device is caused to perform the processing method provided in the present application.

The present application provides a computer program product, including a computer program embodied on a non-transitory computer readable medium, the computer program including program code for performing the processing method provided in the present application.

Compared with the related art, the present application has at least the following advantages.

In the technical solution provided in the present application, an application package (Android® application package, APK) of a target application is obtained by storing some resource packages (e.g., some language packages) in a native resource directory (e.g., an Assets directory) after being compressed, so that a size of the application package is significantly reduced, thereby effectively overcoming defects caused by an excessively large size of the application package. By decompressing and installing the currently needed compression results stored in the native resource directory, the dynamic on-demand installation of resources for the target application can be achieved subsequently following a system configuration (such as a language configuration) of the electronic device, so that the started target application can flexibly meet system configuration requirements (such as language requirements) of different electronic devices, which is beneficial to improving the use experience of the App.

It can be seen that, in the present application, the APK size is reduced by compressing a plurality of resources tiled in the original APK, and the resource is dynamically adjusted on demand in a manner of decompressing and installing the compressed resource when needed, so that a large size drop can be changed at a very small cost, so that the present application is more suitable for a scenario in which no adaptation resource is dynamically downloaded, such as scenarios of pre-installation, third-party application store, and advertisement delivery, etc.

### BRIEF DESCRIPTION OF DRAWINGS

To more clearly illustrate the technical solutions in the embodiments of the present application or related technologies, the accompanying drawings used in the description of the embodiments or the prior art will be briefly introduced below, and it will be apparent that the drawings in the following description are some embodiments of the present disclosure, and those skilled in the art may also acquire other drawings according to these drawings without creative labor.

FIG. 1 is a flowchart of a processing method provided in an embodiment of the present application;

FIG. 2 is a schematic diagram of distribution states of resource packages adapted to different configurations in the same dimension provided in an embodiment of the present application;

FIG. 3 is another schematic diagram of distribution states of resource packages adapted to different configurations in the same dimension provided in an embodiment of the present application;

FIG. 4 is a schematic structural diagram of a processing apparatus provided in an embodiment of the present application; and

FIG. 5 is a schematic structural diagram of an electronic device provided in an embodiment of the present application.

### DETAILED DESCRIPTION

Through research, it has been found that for some applications, since these applications may serve users using different languages, these applications need to meet service requirements of different language types. As a result, when these applications only integrate resources adapted to a certain language type (such as English), it may affect the experience as these resources cannot meet the needs of users in other language types. In addition, since these applications may also be deployed on electronic devices with different screen characteristics (such as different resolutions and the like) to provide services, these applications need to meet the service requirements of different screen characteristics. As a result, when these applications are only integrated with resources adapted to a certain screen characteristic (such as the characteristics of a mobile phone screen), the experience is affected because these resources cannot meet the needs of users with other screen characteristics (such as the characteristics of a computer screen).

Through research, it has also been found that in some scenarios, such as a scenario in which dynamic on-demand download is supported, in order to meet the foregoing requirements, resources may be downloaded dynamically on demand using some application stores, and these application stores are delivered using an Android® App Bundle (AAB) mechanism, so that these application stores can download corresponding resources based on current requirements. The AAB mechanism is a new application posting format, and the AAB mechanism generates APK most suitable for the device according to the characteristics of the user device through dynamic delivery technology, thereby providing a smaller and more efficient application package. For ease of understanding the AAB mechanism, an example is described below with reference to examples.

As an example, for any application store implemented based on the AAB mechanism, the working principle of the application store may include: first, a developer of a certain application provides the AAB file of the application to the application store. This enables the application store, through the AAB mechanism, not only to obtain some APKs from the AAB file but also to select from these APKs and provide some APKs that are necessary for the initial download according to the characteristics of the current device (such as the system language configured by the current device), so as to achieve the initial download and installation of the application. In this way, during the subsequent use of the application, it is possible to download on demand the APKs among the remaining APKs that are adapted to the current requirements (such as language type requirement). In this manner, it is possible to minimize the initial download size of the application as much as possible on the premise of meeting the service requirements of the application, so as to reduce its size.

It should be noted that both the acquisition process and the dynamic download process of the APK may be implemented with the help of a server of the application store. Specifically, after the client of the application store detects an application download request triggered by the user, the server first provides the client with some APKs that are necessary for the initial download, for the user to download, install and uses. Then, after the client detects the use's request for using certain resources (e.g., a certain language) triggered by the user, the server provides the client with the APKs for the resources. In this way, after the download and installation of the APKs of these resources are completed, the corresponding services can be provided to the user. In this manner, dynamic download on demand for the application can be achieved.

It has also been found through research that for some scenarios that do not support the dynamic on-demand download environment, the dynamic distribution solution described by the AAB mechanism can be simulated by means of some tools (such as the bundleTool tool provided by the application store implemented based on the AAB mechanism). In this way, subsequently, by providing the configuration information (such as the system language) of the current device to these tools, the APK with the minimum size that meets the current requirements can be obtained and provided to the user for use.

It has also been found through research that for some scenarios in which the application environment of the AAB mechanism cannot be provided (such as scenarios of pre-installation, third-party stores, advertisement delivery, etc.), all resources need to be integrated in the APK at one time, so that there are resources (e.g., resources of all language types) that meet various service requirements in the APK, which leads to a very large size of the APK, which can easily cause the APK not to meet the size constraint specified by the related personnel or cause the download failure rate to increase due to the fact that the APK size is too large. To facilitate understanding of the reasons for the existence of the aforementioned defects, the following will be illustrated with examples.

As an example, for some scenarios, because these scenarios cannot use the AAB mechanism, in order to ensure that a certain application can meet the language type requirements of different devices (such as Chinese or English requirements), all the language resources may be integrated into the APK of the application. The reason for this processing includes: \textcircled{1} Although APK that integrates only a certain language resource can be produced by means of some tools (such as a bundleTool tool), because the APK is a common file provided by a related personnel for different regions, if only one language resource is integrated in the APK, the language seen by some users in the application may not be a well-known language, which leads to poor experience of these users. (2) Because these scenarios do not support dynamic downloading, the user cannot perform language switching if only one language resource is integrated in the APK, which affects user experience.

It has also been found through research that for the scenario described in the above two paragraphs, the above problem can be solved by manually building an AAB mechanism application environment in these scenarios. However, this solution has the following defects: \textcircled{1} A large resource overhead is required due to a manually built AAB mechanism application environment, which increases the cost and increases the resource pressure of the current device. \textcircled{2} Because some scenarios have their own limitations, these scenarios do not allow the AAB mechanism application environment to be increased. \textcircled{3} Since there may be a conflict between the application environment of the AAB mechanism built manually and the environment configured by these scenarios themselves, some additional problems may be caused and may even interfere with other functions of the current device.

It has also been found through research that in some scenarios, an APK that integrates multiple resources (e.g., multiple language resources) may be implemented by integrating all resources into a Resource directory. In addition, based on the characteristics of the Resource directory itself, it can be learned that the resources cannot be compressed in any way, so that the resources are laid out flat in the APK, resulting in a relatively large size of the APK. It should be noted that the Resource directory refers to a type of directory in an Android® project, so that the directory stores all compiled resource files (such as layout files, pictures, character strings and other resource files), and the resource files stored in this directory can be loaded and used when the App runs.

It should be noted that “loading” refers to reading the stored contents (such as programs or data) on the hard disk into the memory for use when the App runs. Since the memory is a region in which data and programs are temporarily stored in the computer, and its access speed is much faster than that of the hard disk, so that the loaded content can be quickly accessed and executed, thereby improving the running speed and the response time. In addition, the load may occur during the start of the App.

Based on the foregoing research, to resolve the foregoing problem, the present application provides a processing method applied to an electronic device, and the method includes: obtaining an application package of a target application for installation, where the application package includes a native resource directory (e.g., an Asset directory) and a running resource directory (e.g., a resource directory), the native resource directory stores compression results of a plurality of resource packages in a target dimension, different resource packages are adapted to different configurations in the target dimension, and the running resource directory indicates an installed resource file; obtaining a configuration parameter of the electronic device in the target dimension in response to a start request of the target application; and decompressing and installing a compression result of a resource package adapted to the configuration parameter and updating the running resource directory in response to the running resource directory indicating that the resource package adapted to the configuration parameter is not installed and the compression result of the resource package adapted to the configuration parameter is stored in the native resource directory, the updated running resource directory indicating that the resource package adapted to the configuration parameter has been installed.

Herein, the APK of the target application is obtained by storing some resource packages (e.g., some language packages) in the native resource directory after being compressed, so that the size of the application package is significantly reduced, thereby effectively overcoming defects caused by an excessively large size of the application package. By decompressing and installing the currently needed compression results stored in the native resource directory, the dynamic on-demand installation of resources for the target application can be achieved subsequently following a system configuration (such as a language configuration) of the electronic device, so that the started target application can flexibly meet system configuration requirements (such as language requirements) of different electronic devices, which is beneficial to improving the use experience of the App. It can be seen that, in the present application, the size of the APK is reduced by compressing the plurality of resources that are laid out flat in the original APK. Moreover, the present application also achieves the dynamic installation of resources on demand by decompressing and installing the compressed resources when needed. In this way, it is possible to achieve a significant reduction in size at a very low cost, making the present application more suitable for scenarios in which there is no dynamic download of adapted resources, such as scenarios of pre-installation, third-party application stores, advertisement delivery, etc.

In addition, the present application does not limit the execution body of the foregoing processing method. For example, the method may be applied to a terminal device. For another example, the method may also be implemented using a data interaction process between the terminal device and a server. The terminal device may be a smart phone, computer, personal digital assistant (PDA), tablet computer, or the like. The server may be a standalone server, cluster server, or cloud server.

To make those skilled in the art better understand the solutions of the present application, the technical solutions in the embodiments of the present application are clearly and completely described below with reference to the accompanying drawings in the embodiments of the present application. Apparently, the described embodiments are only a part of the embodiments of the present application, rather than all of them. Based on the embodiments in this application, all other embodiments obtained by those skilled in the art without creative efforts shall fall within the protection scope of the present application.

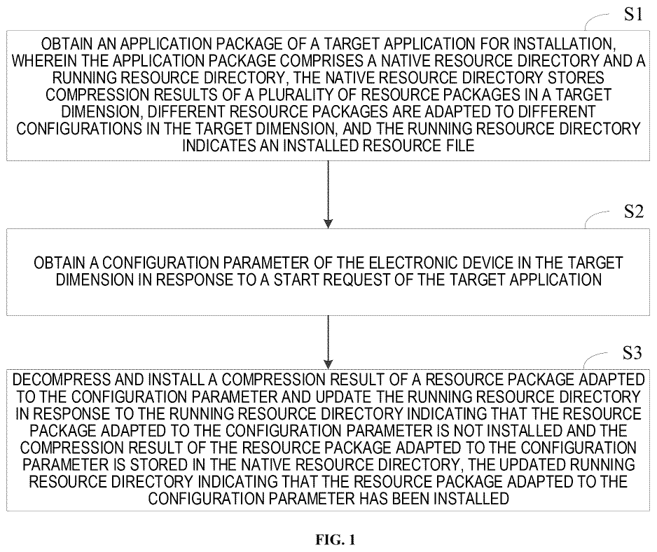

To better understand the technical solutions provided in the present application, the processing method provided in the present application is described below with reference to some accompanying drawings. As shown in FIG. 1, a processing method applied to an electronic device according to an embodiment of the present application includes the following S1-S3.

S1: obtain an application package of a target application for installation, where the application package includes a native resource directory and a running resource directory, the native resource directory stores compression results of a plurality of resource packages in a target dimension, different resource packages are adapted to different configurations in the target dimension, and the running resource directory indicates an installed resource file.

Herein, the electronic device is a device that needs to install a resource dynamically on demand. For example, any terminal device. The electronic device is not limited in the present application.

In addition, in some scenarios, such as a scenario in which an AAB mechanism application environment cannot be provided (such as scenarios of pre-installation, third-party store, advertisement delivery, etc.), the above electronic device may at least meet the following constraint: the electronic device cannot provide an AAB mechanism application environment, so that the electronic device does not support the AAB mechanism, causing the electronic device to be unable to implement the function of dynamically on-demand download of the resource package described by the AAB mechanism. Therefore, in order to overcome the foregoing problem, the electronic device can solve the problem caused by too large size by means of the processing method capable of dynamically on-demand installation of resources provided by the present disclosure.

The target application refers to any App that needs to be deployed and used on the current electronic device.

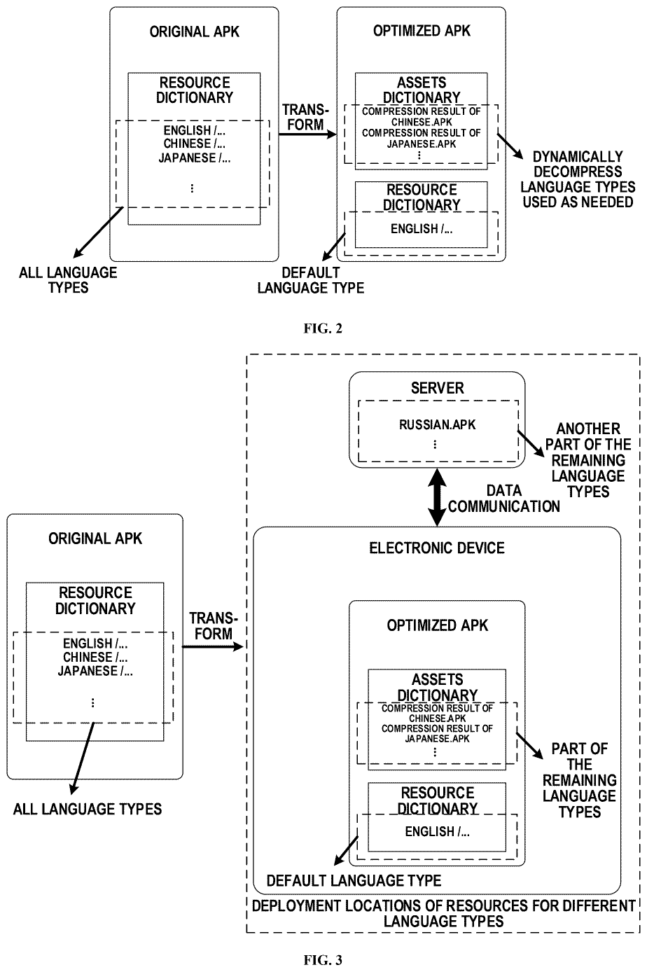

The application package of the target application refers to the APK provided for the target application (e.g., the optimized APK shown in FIG. 2); and the application package may include at least the native resource directory (e.g., an Asset directory) and the running resource directory (e.g., a Resource directory). For ease of understanding, these two directories are separately described below.

For an application package of the above target application, the native resource directory in the application package at least stores compression results (such as compression results shown in FIG. 2) of a plurality of resource packages in a target dimension, and different resource packages are adapted to different configurations (e.g., different language types) in the target dimension, so that different resource packages are suitable for providing services in the target dimension for electronic devices having different configurations. Herein, the target dimension refers to a dimension (e.g., a language type) capable of presenting different configurations on different electronic devices. The present application does not limit the target dimension, and for ease of understanding, two examples are described below with reference to two examples.

Example 1, in some scenarios, such as a multi-language type scenario, the above target dimension may include a language type, so that the native resource directory in an application of the above target application at least stores the compression results of the plurality of resource packages in a language type, and different resource packages are APKs in different language types, so that different resource packages are applicable to providing services for electronic devices configured with different language types, so that a proper resource package can be subsequently selected for installation based on a language type configuration of a system of the current electronic device, which is beneficial to better meet the language type requirements of users for the application.

Example 2, in some scenarios, such as a multi-screen characteristic (e.g., a resolution) scenario, the above target dimension may include screen characteristics (such as screen size, screen resolution, screen type, etc.), so that the native resource directory in the application of the above target application stores at least compression results of the plurality of resource packages under the screen characteristics, and different resource packages are APKs under different screen characteristics respectively, so that different resource packages are suitable for providing services for electronic devices having different screen characteristics. In this way, a proper resource package can be selected for installation subsequently based on the screen characteristics configuration of the system of the current electronic device, which is beneficial to better meet the screen characteristics requirements of users for the application.

It should be noted that the present application does not limit the implementation of the screen characteristic. For example, it may be set according to an actual application scenario.

It should also be noted that, for any resource package, the resource package is a kind of APK, and the resource package can meet the service requirements of certain configuration in the target dimension, so that the current electronic device can better meet the service requirements by obtaining and installing the resource package. In addition, the compression result of the resource package is obtained by compressing the resource package, so that the size of the compression result is smaller than the size of the resource package, so that the size of the APK integrated with the compression result (e.g., the optimized APK shown in FIG. 2) is much smaller than the size of the APK (e.g., the original APK shown in FIG. 2) integrated with the resource package.

It should be further noted that the above native resource directory refers to a kind of directory in an Android® project, so that the directory stores various external resource files (such as image, audio and video, configuration file, font, APK, etc.). In addition, the files stored in the directory are not compiled into a binary file but are stored in an application package of the target application in an original format, so as to be subsequently accessed through an AssetManager class and the like. In addition, the present application does not limit implementations of the directory.

For the application package of the above target application, the running resource directory in the application package indicates resource files already installed on the electronic device at the current moment, so that the resource files stored in the running resource directory can be directly loaded and used when the target application runs, which is beneficial to improving loading efficiency and loading success rate of the resource files.

It should be noted that the running resource directory refers to a kind of directory in an Android® project, so that the directory stores all the compiled resource files (such as layout files, pictures, character strings and other resource files). In addition, the resource files stored in the directory may be directly loaded and used during running of the App. In addition, implementations of the directory are not limited in the present application.

In addition, the present application does not limit the method of obtaining the application package of the above target application. For example, it may be implemented using any application store or any method that provides APK files via certain devices.

In addition, the present application does not limit the implementations of above S1. For example, it may specifically be as follows: first, obtain the application package of the target application in a certain manner. Then, after the installation request triggered for the application package is detected, perform the installation processing on the application package, so that it is necessary to install some resource packages that must be installed within the application package during the installation processing process, so as to achieve the installation process of the application package of the target application.

S2: obtain a configuration parameter of the electronic device in the target dimension in response to a start request of the target application.

Herein, the start request indicates starting the target application, so that the start request indicates switching the target application from the idle state to the running state. It should be noted that the present application does not limit the foregoing implementation of the start request.

Through research, it has been found that since the system configuration of the electronic device usually does not change frequently or even does not change, in order to improve the efficiency, the resources required to be installed for the target application can be adaptively adjusted according to the system configuration (such as language type and other configurations) only when the target application is started for the first time, so as to ensure that the system configuration can be accurately followed when the target application runs for the first time. It can be learned that, in a possible implementation, the start request in S2 may be a start request triggered for the target application for the first time, so that the start request indicates starting the target application for the first time. In this way, by using the solution provided in the present application (such as the solution shown in S2 and S3), the system configuration of the current electronic device can be accurately followed when starting the target application for the first time.

In addition, the foregoing “configuration parameter of the electronic device in the target dimension” is a system parameter predetermined for the electronic device, so that the configuration parameter can represent a feature presented by the electronic device in the target dimension. For example, when the target dimension is a language type, the configuration parameter may represent a language type (e.g., Chinese) predetermined for the system configuration of the electronic device. For another example, when the target dimension is a screen characteristic, the configuration parameter may represent a screen characteristic (such as a screen size, a screen resolution, etc.) of the system configuration for the electronic device.

S3: decompress and install a compression result of a resource package adapted to the configuration parameter and update the running resource directory in response to the running resource directory indicating that the resource package adapted to the configuration parameter is not installed and the compression result of the resource package adapted to the configuration parameter is stored in the native resource directory, the updated running resource directory indicating that the resource package adapted to the configuration parameter has been installed.

In the present application, after the electronic device is installed according to the application package of the target application, the APK that is necessary to be used by some initial installation of the target application is already installed on the electronic device, so that the electronic device can provide some services of the target application to the user. Thus, if it is detected that the start request (e.g., the first start request) triggered by the user for the target application is detected, the electronic device determines, according to the configuration parameter of the electronic device in the target dimension and the running resource directory, whether the resource package adapted to the configuration parameter has been installed on the electronic device at the current moment. If the running resource directory indicates that the resource package adapted to the configuration parameter is still not installed, it can be determined that the resource adapted to the configuration parameter is not installed on the electronic device, so that if it is determined that the compression result of the resource package adapted to the configuration parameter is stored in the native resource directory, the compression result of the resource package adapted to the configuration parameter can be decompressed from the native resource directory for installation, and the running resource directory is updated, so that the updated running resource directory indicates that the resource package adapted to the configuration parameter has been installed. In this way, the system configuration of the electronic device can be correctly followed when the target application is used (e.g., the target application is used for the first time), so that the defect caused by the difference between the feature presented in the target dimension when the target application runs and the feature presented by the electronic device in the target dimension can be effectively overcome, and the user experience is improved.

Based on the related content of S1 to S3, it can be known that the present application reduces the size of APK by compressing the plurality of resources that are laid out flat in the original APK. Moreover, the present application further implements on-demand use by decompressing and installing the compressed resources when needed. In this way, it is possible to achieve a significant reduction in size at a very low cost, making the present application more suitable for scenarios where there is no dynamic loading of adapted resources, such as scenarios of pre-installation, third-party application stores, advertisement delivery, etc.

Through research, it has been found that, for an application store implemented based on the AAB mechanism, the initial download content of the App downloaded from the application store only includes some APKs that is necessary to be used by the initial installation, so that some resource packages are downloaded dynamically on demand during subsequent use of the App. Herein, the resource packages downloaded on demand are placed in a unified Android® resource package path, so that after the App is started, the installation of the resource package in this path can be carried out by calling the Android® software development kit (SDK), and thus the loading of the corresponding resources can be completed.

Based on the principle shown in the foregoing paragraph, in order to ensure that the resource needs to be installed dynamically on a single end, if the application package of the above target application includes the native resource directory (e.g., an Asset directory), the running resource directory (e.g., a Resource directory), and a supplementary resource directory (e.g., an Android® resource package path), and the supplementary resource directory indicates a storage path of decompression results of respective compression results, the foregoing S3 may be specifically as follows: decompress the compression result of the resource package adapted to the configuration parameter to the supplementary resource directory for installation and update the running resource directory in response to the running resource directory indicating that the resource package adapted to the configuration parameter is not installed and the compression result of the resource package adapted to the configuration parameter is stored in the native resource directory, the updated running resource directory indicating that the resource package adapted to the configuration parameter has been installed.

Herein, the above supplement resource directory refers to a predetermined directory that stores the decompression results of respective compression results, so that the supplementary resource directory can represent the storage path of the decompression results. In this way, subsequently, the dynamic on-demand installation of resources can be achieved by promptly installing the newly decompressed results in the supplementary resource directory.

In addition, the present application does not limit the implementation manner of the foregoing supplementary resource directory. For example, in a possible implementation, the supplementary resource directory may be implemented using an Android® resource package path involved in the foregoing AAB mechanism, and a resource package that needs to be dynamically installed is stored in the supplementary resource directory, so that all resource packages that need to be dynamically installed can be placed in the same path. This further enables the subsequent determination of whether additional new resources need to be loaded during the runtime of the target application by detecting whether new resource packages have been added to the path.

It can be learned from the foregoing three paragraphs that, after it is installed on the electronic device according to the application package of the target application, if the start request (e.g., the first start request) triggered by the user for the target application is detected, some judgment is performed according to the configuration parameter of the electronic device in the target dimension, so that if it is determined that the running resource directory indicates that the resource package adapted to the configuration parameter is not installed and the compression result of the resource package adapted to the configuration parameter is stored in the native resource directory, the compression result of the resource package adapted to the configuration parameter may be decompressed from the native resource directory to the supplementary resource directory, so that the newly added resource package in the supplementary resource directory can be subsequently installed in a certain manner (such as calling the Android® SDK manner), thereby ensuring that the path of each dynamic installation is fixed and facilitating simplification of the dynamic installation effect.

It can be seen that the present application simulates the process of dynamically downloading the resource from the server of the application store to the fixed directory, which is achieved through the AAB mechanism, by decompressing the corresponding resource from the “assets” directory to the fixed directory, so that the effect presented by the simple process of compressing and decompressing performed on the single end can achieve the effect presented by the dynamic on-demand download resource process realized through the multi-end interaction, thereby facilitating better implementation of a large size reduction at minimal cost under the premise of meeting various service requirements as much as possible.

In addition, in order to better overcome the defects caused by too large size, the present application further provides a process of building the application package of the target application, which may be as follows: first, dismantle a post file (e.g., an AAB file) of the target application into a plurality of application packages, so that the plurality of application packages include a basic package (e.g., an APK that is necessary to be used for initial installation) and a plurality of resource packages (e.g., a plurality of language resource packages) in the above target dimension; and then building the application package of the target application based on the compression results of respective resource packages in the plurality of resource packages and the basic package, so that the running resource directory in the application package of the target application indicates that an installation process of the application package of the target application (as the installation process described in S1) includes installing the basic package, which is beneficial to greatly reducing the size of the application package.

The post file of the target application refers to a file (e.g., an AAB file) provided by the related personnel for the target application and capable of installing and distributing the application, so that the file can describe all functions of the target application. In addition, the present application does not limit the method for dismantling the file. For example, it may be implemented by any method capable of dismantling the file into a plurality of APKs (e.g., by means of a bundleTool or manually dismantling).

In addition, the present application does not limit the implementation of the step of “building the application package of the target application based on the compression results of respective resource packages in the plurality of resource packages and the basic package”. For example, it may be specifically as follows: integrate (e.g., store) the basic package into the Resource directory in a certain manner, and store the compression results of the resource packages in the Assets directory to obtain the application package of the target application, so that only the basic package needs to be installed if the installation request triggered for the application package is detected, and the resource packages do not need to be installed. This is beneficial for improving installation efficiency.

It has been found through research that the resource loading process implemented in the manner of decompression and installation may have the phenomena of relatively long-time consumption and relatively low success rate. Thus, in order to overcome the impacts caused by this phenomenon as much as possible (e.g., the impact of taking a long time to load language resources or being unable to load language resources, etc.), the fallback resource in the target dimension (such as the default language type shown in FIG. 2) may be reserved in the Resource directory.

Based on the foregoing research, in order to better improve user experience, the present application further provides a process of building the application package of the target application, which may be as follows: first, dismantle a post file of the target application into a plurality of application packages, so that the plurality of application packages include a basic package, a plurality of resource packages in the target dimension, and a default resource package in the target dimension, and a configuration adapted to the default resource package in the target dimension is different from a configuration adapted to respective resource packages of the plurality of resource packages in the target dimension; and based on the compression results of respective resource packages in the plurality of resource packages, the default resource package, and the basic package, build the application package of the target application (as shown in the optimized APK shown in FIG. 2), so that the running the resource directory in the application package of the target application indicates that the installation process of the application package of the target application includes installing the basic package and installing the default resource package, which can effectively ensure that the fallback resource in the target dimension has been installed in the running of the target application, thereby helping to better overcome the problem caused by the phenomenon that the time consumption is relatively long and the success rate is relatively low when the resource loading process implemented in the manner of decompression and installation, thereby helping to better improve the user experience.

It can be seen that, after the AAB file of the target application is obtained, the AAB file can be dismantled into a plurality of APKs, so that the APKs not only include the basic package but also include some language resource packages, so that part of the language resource packages in these language resource packages are considered as default resource packages to be integrated (e.g., stored) into the Resource directory, and the remaining language resource packages in the language resource packages are regarded as resource packages selected on demand, and are stored in the Resource directory after being compressed to obtain the application package of the target application. In this way, only the basic package and the default resource package need to be installed if an installation request triggered for the application package is detected, and these on-demand selected resource packages do not need to be installed, so that it can be ensured that when the target application runs, a fallback can be provided by loading the default resource package, which is beneficial for improving the user experience.

In addition, the present application does not limit the number of default resource packages. For example, it may be implemented using a fixed number (e.g., 1) set according to a current application scenario.

Through research, it has been found that because the default resource package is directly stored in the Resource directory, and the default resource package cannot be compressed, so that the size of the APK that is finally built based on the default resource package is relatively large, and the size of the finally built APK is greatly increased along with the increase of the number of the default resource packages. Therefore, the present application can achieve the maximum reduction in size as much as possible by reducing the number of default resource packages as much as possible.

It has also been found through research that, because the default resource package stored in the resource directory in the use process of the target application can be directly loaded, but the resource stored in the Assets directory needs to be decompressed and installed before loading, so that the loading process of the latter resource is complicated than the loading process of the former resource, so that the loading time consumption of the latter resource is longer than that of the former resource, and the loading success rate of the latter resource is smaller than the loading success rate of the former resource. Therefore, to better improve the loading effect, the present application can optimize the loading time consumption and the loading success rate as much as possible by considering all the resource packages that the user may use as the default resource package as much as possible.

Based on the two studies, in order to better improve the flexibility, the number of the default resource packages may be determined based on one of: a size constraint of the application package of the target application or a running constraint of the target application on the electronic device, so that the APK finally built based on the default resource package can reduce the size as much as possible on the premise of meeting the size constraint and/or the requirements of the electronic device.

The foregoing “size constraint of the application package of the target application” indicates a maximum size of the application package of the target application, so that the size of the APK that is finally built based on the size constraint does not exceed the maximum size, and the finally built APK meets the size constraint. In addition, the size constraint may be set according to an actual application scenario, and the present application does not limit the manner of obtaining the size constraint.

The foregoing “running constraint of the target application on the electronic device” indicates a maximum time consumption and/or a maximum success rate of running the target application according to the configuration parameter of the electronic device in the target dimension. In this way, the running constraint can, to a certain extent, limit the maximum time consumed when loading the resource package adapted to the configuration parameter and/or the maximum possibility of successfully loading the resource package adapted to the configuration parameter, so that the APK finally built based on the running constraint can meet the running constraint. In addition, the running constraint may be set according to an actual application scenario, and the present application does not limit the manner of obtaining the running constraint.

It should be noted that the present application does not limit the implementation of the process of determining the number of default resource packages described in the foregoing three paragraphs. For example, it may be implemented using a predetermined mapping relationship. Herein, because the mapping relationship can describe a correspondence between the number of default resource packages and some constraints (such as size constraints and/or running constraints), the number of default resource packages can be subsequently found from the mapping relationship as the number of the default resource packages. For another example, the number of the default resource packages may be determined by means of a pre-built machine learning model with the performance of predicting the number.

Through research, it has been found that the same APK may be compressed using different compression algorithms. Because different compression algorithms present different compression rates, so that sizes presented by the same resource package after experiencing different compression algorithms are different. Therefore, in order to better improve flexibility, for any resource package in a plurality of resource packages in the target dimension, a compression algorithm for the resource package may be determined based on at least one of: a size of a posted file of the target application, a size constraint of the application package of the target application, or a running constraint of the target application on the electronic device, so that an APK built based on the compression result of the resource package under the compression algorithm can reduce the size as much as possible on the premise of meeting the size constraint and/or requirements of the electronic device.

It should be noted that the present application does not limit the implementation manner of the process of determining the compression algorithm shown in the foregoing paragraph. For example, it may be implemented using a predetermined mapping relationship. Because the mapping relationship describes a correspondence between a compression algorithm and some information (e.g., information such as a size, size constraint, and running constraint of the AAB file), a compression algorithm corresponding to the currently involved information can be subsequently found from the mapping relationship to perform corresponding compression processing. As another example, it may be implemented with a pre-built machine learning model with the prediction performance of compression algorithm.

Through research, in some scenarios, such as a scenario in which the default resource package is integrated in the initial Resource directory, or in other scenarios, for a target application that has been installed, because the Resource directory involved in the target application can accurately represent which resource files (e.g., which language resource package) has been installed on the electronic device, whether a resource currently required to be used (such as a Chinese resource package) has been installed subsequently can be determined by means of the Resource directory.

Based on the above research, in order to better improve the efficiency, the above processing method may at least include the following steps: in response to the running resource directory (e.g., the Resource directory) indicating that the resource package adapted to the configuration parameter has been installed, loading the resource package adapted to the configuration parameter.

It can be seen that, if the application package of the target application includes the native resource directory, the running resource directory, and the supplementary resource directory, after the electronic device installs the application package of the target application according to the application package of the target application, if it is detected that the first start request triggered by the user for the target application is detected, it is determined whether the resource package adapted to the configuration parameter of the electronic device in the target dimension is already installed on the electronic device according to the running resource directory (e.g., the Resource directory). If yes, it can be determined that the default resource package stored in the running resource directory adapts to the configuration parameter, so that it can be determined that the currently installed resource package can correctly follow the system configuration of the electronic device. Therefore, the resource package adapted to the configuration parameter can be directly loaded. If not, the compression result of the resource package adapted to the configuration parameter is decompressed from the native resource directory to the supplementary resource directory, so that the newly added resource package (such as the resource package adapted to the configuration parameter) in the supplementary resource directory is installed by means of calling the Android® SDK. Therefore, after the installation is completed, the running resource directory is updated, so that the updated running resource directory indicates that the resource package adapted to the configuration parameter has been installed, and the resource package adapted to the configuration parameter is loaded. In this way, the system configuration of the electronic device can be correctly followed when the application is used for the first time by means of decompression and installation.

In addition, in some scenarios, such as scenario of adjusting the system configuration of the electronic device halfway, if the application package of the target application includes the native resource directory, the running resource directory, and the supplementary resource directory, and the target application has been installed and used for a period of time, if it is detected that the configuration parameter of the electronic device in the target dimension is updated, then if it is detected that the start request triggered by the user for the target application is detected (such as the start request that occurs later than the occurrence time of the update and is the closest to the update in terms of time), it is determined, according to the running resource directory (e.g., a Resource directory), whether the resource package adapted to the configuration parameter of the electronic device in the target dimension is already installed on the electronic device. If yes, it is determined that the resource package adapted to the configuration parameter has been stored in the running resource directory, so that it can be determined that the currently installed resource package can correctly follow the system configuration of the electronic device. Therefore, the resource package adapted to the configuration parameter can be directly loaded. If not, the compression result of the resource package adapted to the configuration parameter is decompressed from the native resource directory to the supplementary resource directory, so that the newly added resource package (such as the resource package adapted to the configuration parameter) in the supplementary resource directory is installed by means of calling the Android® SDK. Therefore, after the installation is completed, the running resource directory is updated, so that the updated running resource directory indicates that the resource package adapted to the configuration parameter has been installed, and the resource package adapted to the configuration parameter is loaded. In this way, the system configuration of the electronic device can be followed in real time and correctly when the application is used by means of decompression and installation.

Through research, it has been found that, for some scenarios, the possibility that different resource packages in the target dimension are used by users is different, and even a large difference exists, so that some resource packages are used in a large probability, but some other resource packages are almost impossible to use. Some resource packages that are almost impossible to be used are stored in the APK finally built based on all the resource packages, which causes a certain degree of size waste. Therefore, in order to overcome the foregoing problems, some resource packages with relatively high usage possibility can be integrated into the application package of the target application, and the remaining resource packages with relatively low possibility of use are saved to the server, so that the resource packages with relatively low probability of usage can be obtained subsequently through data communication with the server. In this way, the size can be reduced as much as possible on the premise of meeting various service requirements.

Based on the foregoing research, in a possible implementation, if the application package of the target application includes at least a native resource directory and a running resource directory, the foregoing processing method may include at least the following steps: in response to the running resource directory indicating that the resource package adapted to the configuration parameter is not installed, and the compression result of the resource package adapted to the configuration parameter is not stored in the native resource directory, obtain, from a server, the resource package adapted to the configuration parameter for installation. Herein, the server refers to a server end capable of performing data communication with the current electronic device, so that the server may provide at least one resource package in a target dimension to the target application through a data communication process between different ends. In addition, a usage probability (usage possibility) of a resource package obtained from the server is less than a usage probability of a resource package obtained from the native resource directory, so that most of the electronic devices can quickly obtain some resource packages with relatively high usage probability by means of the application package in the usage scenario of the target application, and a small amount (or even no) of electronic devices need to obtain some resource packages with relatively low usage probability by means of the server, which helps to reduce the size as much as possible on the premise of meeting various service requirements.

It should be noted that, the present application does not limit the implementation of the step of “obtaining the resource package adapted to the configuration parameter from the server”. For example, it may be specifically as follows: generate a resource request if it is detected that the compression result of the resource package adapted to the configuration parameter is not stored in the native resource directory; and send the resource request to the server, so that the server can search for the resource package adapted to the configuration parameter based on the configuration parameter carried in the resource request and feed back to the electronic device.

It should also be noted that, the present application does not limit the implementation of the step of “obtaining the resource package adapted to the configuration parameter from the server for installation”. For example, if the application package of the target application further includes the supplementary resource directory, the step may be specifically as follows: store the resource package adapted to the configuration parameter obtained from the server to the supplementary resource directory for installation, so as to ensure that the resource packages obtained in different manners can be installed in the same manner, which is beneficial to simplifying the process of dynamically installing the resource.

It should be further noted that, for the server illustrated in the foregoing two paragraphs (such as the server shown in FIG. 3), the present application does not limit the implementation of the server, and it is only needed to ensure that the server meets the following constraint: the server can perform data communication with the current electronic device.

It should be further noted that the present application does not limit the relationship between the default resource package, the resource package obtained from the native resource directory, and the resource package obtained from the server. For example, it may be: the usage probability (usage possibility) of the default resource package>the usage probabilities of respective resource packages obtained from the native resource directory>the usage probabilities of respective resource packages obtained from the server, so that the resource loading solution implemented based on the relationship has the following characteristics: when the target application is used (e.g., starting and/or running), the electronic device can consume the shortest time and can load the resource packages with the highest usage probability (such as the default resource package) with the highest success probability; the electronic device can consume more time and can load the resource package with the slightly lower usage probability with a lower success probability (e.g., the resource package obtained by decompressing the compressed result stored in the native resource directory); the electronic device can consume the most time and can load the resource packages with the lowest usage probability (such as the resource package provided by the server) with the lowest success probability.

It can be seen that, in a possible implementation, the process of building the application package of the target application may be as follows: first, dismantle a post file (e.g., an AAB file) of the target application into a plurality of application packages, so that the plurality of application packages include a basic package (e.g., the APK that is necessary to be used for initial installation) and some resource packages (e.g., a plurality of language resource packages) in the target dimension, so that the resource packages include a first resource package with the usage possibility greater than a first threshold (e.g., 90%), a second resource package with the usage possibility between the first threshold and a second threshold (e.g., 30%), and a third resource package with the usage possibility lower than the second threshold, where the first threshold is greater than the second threshold; then, send respective third resource packages to any server capable of performing data communication with the current electronic device for storage, and build the application package of the target application based on the compression results of respective second resource packages, respective first resource packages and the basic package, so that the running the resource directory in the application package of the target application indicates that the installation process of the application package of the target application includes installing the basic package and respective first resource packages. In this way, it is beneficial to better reduce the size.

Through research, it has been found that in some scenarios, the user wants to switch the configuration (such as Chinese) presented by the target application in the target dimension to other configurations, and no longer follows the system configuration of the electronic device, so that the configuration switching requirement (such as the language type switching requirement) under the target dimension is better met.

Based on the foregoing research, in order to better meet the foregoing requirement, if an application package of a target application includes at least a native resource directory and a running resource directory, the foregoing processing method may include at least the following steps: in response to a configuration switching request in the target dimension, obtaining a target configuration (e.g., Russian) indicated by the configuration switching request; and in response to the running resource directory indicating that a resource package adapted to the target configuration is not installed and a compression result of a resource package adapted to the target configuration is stored in the native resource directory, decompress the compression result of the resource package adapted to the target configuration, restart the target application, install the resource package adapted to the target configuration obtained through decompression, and update the running resource directory, so that the updated running resource directory indicates that the resource package adapted to the target configuration has been installed.

It should be noted that, the present application does not limit the foregoing implementation of “decompressing the compression result of the resource package adapted to the target configuration, restarting the target application, and installing the resource package adapted to the target configuration obtained through decompression”. For example, if the application package of the target application further includes a supplementary resource directory, the step may specifically be as follows: decompress the compression result of the resource package adapted to the target configuration to the supplementary resource directory, restart the target application, and install the newly added resource file (such as the resource package adapted to the target configuration) in the supplementary resource directory.

Based on the foregoing two paragraphs, if the application package of the target application includes the native resource directory, the running resource directory, and the supplemental resource directory, and the target application is in the running state, if it is detected that the user triggers the configuration switching request in the target dimension for the target application, and the configuration switching request carries “switching the current configuration (e.g., Chinese) in the target dimension to the target configuration (e.g., Russian) in the target dimension”, it is determined, based on the running resource directory (e.g., the Resource directory), whether the resource package adapted to the target configuration has been installed on the electronic device. If yes, it may be determined that the resource package adapted to the target configuration is historically installed, so that the resource package adapted to the target configuration may be directly loaded. However, if not, it may be determined that the resource package adapted to the target configuration is not installed in history, so that the resource package adapted to the target configuration may be obtained from the native resource directory or the server, and the resource package adapted to the target configuration may be stored in the supplementary resource directory. After the target application is restarted, the newly added resource package (such as the resource package adapted to the target configuration) in the supplementary resource directory is installed by means of calling the Android® SDK, so that the running resource directory is updated after the installation is completed. Therefore, the updated running resource directory indicates that the resource package adapted to the target configuration has been installed, and the resource package adapted to the target configuration is loaded, so that the configuration switching in the target dimension can be achieved. This is beneficial for improving the user's experience.

Based on the related content of the above processing method, the technical solutions provided in the present application are optimized from the build of the APK and the usage of the APK, so that the optimized solution has the following advantages: the size is reduced by compressing some resource packages that are laid out flat in the original APK; and the resource package is dynamically installed on demand by decompressing and installing the compressed language package. For ease of understanding, the following describes a multi-language type scenario as an example.

For the optimization solution implemented from the aspect of the build of the APK, the solution includes: dismantling an AAB file into a plurality of APKs (e.g., a basic package and some language resource packages), selecting a part of language resource packages from the APKs for compression and storing them in an Assets directory, and storing the basic package and the remaining language resource packages as fallback information in the Resource directory. Since the part of language resource packages are stored in the Assets directory through one round of compression, the size of the application package of the target application finally built based on the Assets directory is greatly reduced. Therefore, the problem that respective language resource packages in the application package of the target application are integrated in a tiled manner can be effectively overcome. In addition, because the part of the language resource packages may be compressed using different compression algorithms, the compression results of the part of the language resource packages under different compression algorithms are presented with different compression rates, so that the most appropriate compression algorithm may be flexibly selected based on the requirements of the current scenario when the actual application is applied, which helps to reduce the size as much as possible on the premise of meeting the requirement.

For the optimization solution implemented from the aspect of the usage of the APK, the solution includes: (1) when starting for the first time, it is determined that the system language configuration of the current electronic device is adapted to the default language package stored in the Resource directory. If adapted, the installed default language package is directly loaded. If not adapted, the compression result of the language package adapted to the system language configuration from the Assets directory is decompressed to a pre-specified fixed path (e.g., the path of the Android® language package), then the Android® SDK is called to install “the language package adapted to the system language configuration” stored in the fixed path, so that the system language configuration of the electronic device can be correctly followed for the first usage. (2) When the language is switched, the compression result of the target language package is decompressed from the Assets to the fixed path. After the APP is restarted, the Android® SDK is called to install the target language package stored in the fixed path to complete the language switching. It can be seen that this optimization solution decompresses the compressed language package stored in Assets to the fixed path, replacing the process in which the application store implemented based on the AAB mechanism stores the language package downloaded on demand from its server to this fixed path. In this way, it is possible to dynamically install resources on demand by means of a single end, that is, the electronic device, without having to deploy an environment for dynamically downloading resources on demand based on multi-end communication. As a result, it is possible to achieve a significant reduction in size at a very low cost.

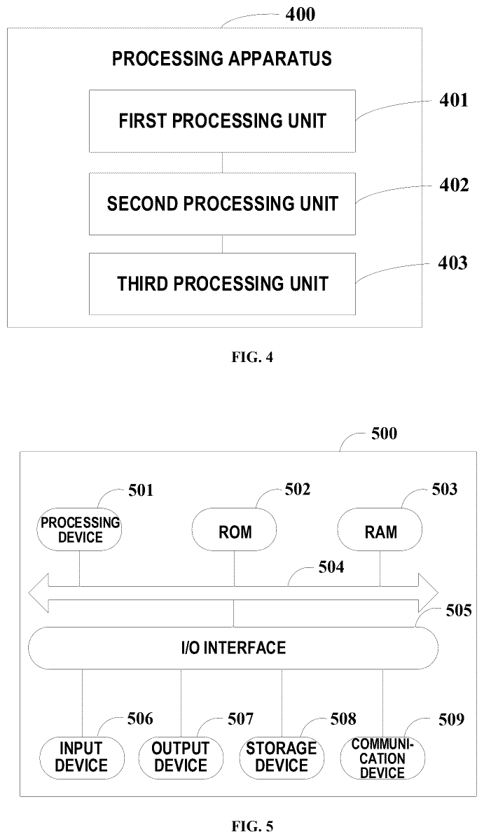

Based on the processing method provided in the embodiments of the present application, the embodiments of the present application further provide a processing apparatus, which is explained and described below with reference to FIG. 4. FIG. 4 is a schematic structural diagram of a processing apparatus provided in the embodiments of the present application. It should be noted that for technical details of the processing apparatus provided in the embodiments of the present application, please refer to related content of the processing method described above.

As shown in FIG. 4, a processing apparatus 400 provided in the embodiments of the present application includes the following units.

A first processing unit 401 is configured to obtain an application package of a target application for installation, where the application package includes a native resource directory and a running resource directory, the native resource directory stores compression results of a plurality of resource packages in a target dimension, different resource packages are adapted to different configurations in the target dimension, and the running resource directory indicates an installed resource file.

A second processing unit 402 is configured to obtain a configuration parameter of the electronic device in the target dimension in response to a start request of the target application.

A third processing unit 403 is configured to decompress and install a compression result of a resource package adapted to the configuration parameter and update the running resource directory in response to the running resource directory indicating that the resource package adapted to the configuration parameter is not installed and the compression result of the resource package adapted to the configuration parameter is stored in the native resource directory, the updated running resource directory indicating that the resource package adapted to the configuration parameter has been installed.

In a possible implementation, the start request indicates starting the target application for the first time.

In a possible implementation, the application package further includes a supplementary resource directory, and the supplementary resource directory indicates a storage path of decompression results for respective compression results; and the third processing unit 403 is specifically configured to decompress the compression result of the resource package adapted to the configuration parameter to the supplementary resource directory for installation.

In a possible implementation, a process of building the application package of the target application includes: dismantling a post file of the target application into a plurality of application packages, where the plurality of application packages include a basic package and the plurality of resource packages; and building the application package of the target application based on the compression results of respective resource packages in the plurality of resource packages and the basic package, where the running resource directory in the application package of the target application indicates that an installation process of the application package of the target application includes installing the basic package.

In a possible implementation, the plurality of application packages further include one or more default resource packages in the target dimension, and a configuration adapted to the default resource package in the target dimension is different from a configuration adapted to respective resource packages of the plurality of resource packages in the target dimension; and a process of building the application package of the target application specifically includes: building the application package of the target application based on the compression results of respective resource packages in the plurality of resource packages, the default resource package and the basic package, where the running resource directory in the application package of the target application indicates that the installation process of the application package of the target application further includes installing the default resource package.

In a possible implementation, a number of the default resource packages is determined based on at least one of: a size constraint of the application package of the target application or a running constraint of the target application on the electronic device, the size constraint indicates a maximum size of the application package of the target application, and the running constraint indicates at least one of: a maximum time consumption or a maximum success rate of running the target application according to the configuration parameter of the electronic device in the target dimension.

In a possible implementation, a compression algorithm for respective resource packages of the plurality of resource packages is determined based on at least one of: a size of the post file, a size constraint of the application package of the target application, or a running constraint of the target application on the electronic device, the size constraint indicates a maximum size of the application package of the target application, and the running constraint indicates at least one of: a maximum time consumption or a maximum success rate of running the target application according to the configuration parameter of the electronic device in the target dimension.

In a possible implementation, the processing apparatus 400 further includes: a resource loading unit, configured to load the resource package adapted to the configuration parameter in response to the running resource directory indicating that the resource package adapted to the configuration parameter has been installed.

In a possible implementation, the processing apparatus 400 further includes: a fourth processing unit, configured to obtain, from a server, the resource package adapted to the configuration parameter for installation in response to the running resource directory indicating that the resource package adapted to the configuration parameter is not installed and the compression result of the resource package adapted to the configuration parameter is not stored in the native resource directory, where the server provides at least one resource package in the target dimension to the target application, and a usage probability of a resource package obtained from the server is less than a usage probability of a resource package obtained from the native resource directory.

In a possible implementation, the processing apparatus 400 further includes: a configuration switching unit, configured to obtain a target configuration indicated by a configuration switching request in response to the configuration switching request in the target dimension; and in response to the running resource directory indicating that a resource package adapted to the target configuration is not installed and a compression result of the resource package adapted to the target configuration is stored in the native resource directory, decompress the compression result of the resource package adapted to the target configuration; restart the target application; install the resource package adapted to the target configuration obtained through decompression; and update the running resource directory, the updated running resource directory indicating that the resource package adapted to the target configuration has been installed.

In a possible implementation, the target dimension includes a language type.

In a possible implementation, the processing apparatus 400 is deployed on an electronic device, and the second processing unit 402 is specifically configured to: in response to a start request of the target application, obtain a configuration parameter of the electronic device in the target dimension.

It can be learned from the related content of the foregoing processing apparatus 400 that the working principle of the apparatus 400 includes: an application package of a target application is obtained by storing some resource packages (e.g., some language packages) in a native resource directory (e.g., an Assets directory) after being compressed, so that a size of the application package is significantly reduced, thereby effectively overcoming defects caused by an excessively large size of the application package. By decompressing and installing the currently needed compression results stored in the native resource directory, the dynamic on-demand installation of resources for the target application can be achieved subsequently following a system configuration (such as a language configuration) of the electronic device, so that the started target application can flexibly meet system configuration requirements (such as language requirements) of different electronic devices, which is beneficial to improving the use experience of the App.

In addition, the embodiments of the present application further provide an electronic device, which includes a processor and a memory, where the memory is configured to store instructions or a computer program, and the processor is configured to execute the instructions or the computer program in the memory to cause the electronic device to perform the processing method provided in the present application.

Referring to FIG. 5, which shows a schematic structural diagram of an electronic device 500 suitable for implementing the embodiments of the present disclosure. The terminal device in the embodiments of the present disclosure may include, but is not limited to, a mobile terminal such as a mobile phone, a notebook computer, a digital broadcast receiver, a personal digital assistant (PDA), a portable Android® devices (PAD), a portable media players (PMP), a car-mounted terminal (e.g., a vehicle navigation terminal), and a fixed terminal such as a digital TV, a desktop computer, or the like. The electronic device shown in FIG. 5 is merely an example and should not impose any limitation on the functions and scope of use of the embodiments of the present disclosure.

As shown in FIG. 5, the electronic device 500 may include a processing device (e.g., a central processor, a graphics processor, etc.) 501, which may perform various appropriate actions and processing according to a program stored in a read-only memory (ROM) 502 or a program loaded into a random-access memory (RAM) 503 from a storage device 508. In the RAM 503, various programs and data required by the operation of the electronic device 500 are also stored. The processing device 501, the ROM 502, and the RAM 503 are connected to each other through a bus 504. Input/output (I/O) interface 505 is also connected to the bus 504.

Generally, the following devices can be connected to the I/O interface 505: an input device 506 including, for example, touch screens, touchpads, keyboards, mice, cameras, microphones, accelerometers, gyroscopes, etc.; an output device 507 including liquid crystal displays (LCDs), speakers, vibrators, etc.; a storage device 508 including magnetic tapes, hard disks, etc.; and a communication device 509. The communication device 509 may allow the electronic device 500 to communicate with other devices wirelessly or wired to exchange data. Although FIG. 5 illustrates the electronic device 500 with various devices, it should be understood that it is not required to implement or have all the devices shown. It can be implemented or equipped with more or fewer devices as an alternative.

In particular, according to the embodiments of the present disclosure, the process described above with reference to the flowchart can be implemented as a computer software program. For example, an embodiment of the present disclosure includes a computer program product, and the computer program product includes a computer program carried on a computer readable medium, where the computer program includes program code for performing a method for recommending words. In such an embodiment, the computer program can be downloaded and installed from a network through the communication device 509, or installed through the storage device 508, or installed through the ROM 502. When the computer program is executed by the processing device 501, the above functions defined in the method of the embodiment of the present disclosure are performed.

The electronic device provided by the embodiments of the present disclosure and the method provided in the foregoing embodiments belong to the same inventive concept, and technical details not described in detail in this embodiment may refer to the foregoing embodiments, and this embodiment has the same beneficial effects as the foregoing embodiments.

The embodiments of the present application further provide a computer readable medium, where the computer readable medium stores instructions or a computer program, and when the instructions or the computer program runs on a device, the device is enabled to perform any implementation of the processing method provided in the embodiments of the present application.

It should be noted that the computer-readable medium described above can be a computer-readable signal medium or a computer-readable storage medium, or any combination thereof. The computer-readable storage medium can be. For example, but not limited to, an electrical, magnetic, optical, electromagnetic, infrared, or semiconductor system, apparatus, or device, or any combination thereof. The computer-readable storage media may include but are not limited to: an electrical connection with one or more wires, a portable computer disk, a hard disk, random access memory (RAM), read-only memory (ROM), an erasable programmable read only memory (EPROM or flash memory), an optical fiber, a portable compact disk read only memory (CD-ROM), an optical storage device, a magnetic storage device, or any combination thereof. In the present disclosure, a computer-readable storage medium may be any tangible medium containing or storing a program that can be used by an instruction execution system, apparatus, or device, or can be used in combination with an instruction execution system, apparatus, or device. In the present disclosure, a computer-readable signal medium can include a data signal propagated in baseband or as a carrier wave, the computer-readable signal medium carries computer-readable program code therein. Such propagated data signals may take many forms, including but not limited to electromagnetic signals, optical signals, or any combination thereof. A computer-readable signal medium may also be any computer-readable medium other than a computer-readable storage medium, which can send, propagate, or transmit programs for use by or in conjunction with instruction execution systems, apparatus, or devices. The program code contained on the computer-readable medium may be transmitted using any suitable medium, the medium includes but not limited to: wires, optical cables, RF (radio frequency), etc., or any combination thereof.

In some implementations, clients and servers may communicate using any currently known or future developed network protocol, such as Hyper Text Transfer Protocol (HTTP), and may be interconnected with any form or medium of digital data communication (e.g., communication network). Examples of communication networks include local area networks (“LANs”), wide area networks (“WANs”), internets (e.g., the Internet), and peer-to-peer networks (e.g., ad hoc peer-to-peer networks), as well as any currently known or future developed networks.

The computer readable medium may be included in the electronic device or may exist separately without being assembled into the electronic device.

The computer readable medium carries one or more programs, and when the one or more programs are executed by an electronic device, the electronic device may perform the foregoing method.

Computer program codes for performing the operations of the present disclosure may be written in one or more programming languages or a combination thereof, including but not limited to Object Oriented programming languages-such as Java, Smalltalk, C++, and also conventional procedural programming languages-such as “C” or similar programming languages. The program code may be executed entirely on the user's computer, partially executed on the user's computer, executed as a standalone software package, partially executed on the user's computer and partially on a remote computer, or entirely on a remote computer or server. In the case of involving a remote computer, the remote computer may be any kind of network-including local area network (LAN) or wide area network (WAN)-connected to the user's computer or may be connected to an external computer (e.g., through an Internet service provider to connect via the Internet).

The flowcharts and block diagrams in the accompanying drawings illustrate the architecture, functions, and operations of possible implementations of the system, method, and computer program product of various embodiments of the present disclosure. Each block in a flowchart or block diagram may represent a module, program segment, or portion of code that contains one or more executable instructions for implementing a specified logical function. It should also be noted that in some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Units described in the embodiments of the present disclosure may be implemented by means of software or hardware. In some cases, the name of a unit/module does not constitute a limitation on the unit itself.

The functions described herein above can be performed at least in part by one or more hardware logic components. For example, without limitation, example types of hardware logic components that may be used include: a field programmable gate array (FPGA), an application specific integrated circuits (ASIC), an application specific standard part (ASSP), a system on chip (SOC), a complex programmable logic device (CPLD), and so on.

In the context of present disclosure, a machine-readable medium can be a tangible medium that may contain or store programs for use by or in conjunction with instruction execution systems, apparatuses, or devices. A machine-readable medium may be a machine-readable signal medium or a machine-readable storage medium. A machine-readable medium may include, but are not limited to, electronic, magnetic, optical, electromagnetic, infrared, or semiconductor systems, apparatuses, or devices, or any suitable combination thereof. Specific examples of the machine-readable storage medium may include electrical connections based on one or more wires, portable computer disks, hard disks, RAM, ROM, EPROM or flash memory, optical fibers, CD-ROM, optical storage devices, magnetic storage devices, or any combination thereof.

It should be noted that the embodiments in this specification are described in a progressive manner, and each embodiment focuses on differences from other embodiments, and the same or similar parts between the embodiments may refer to each other. For the system or apparatus disclosed in the embodiments, since the system or apparatus corresponds to the method disclosed in the embodiments, the description is relatively simple, and the relevant part may be referred to the method part description.

It should be understood that, in the present application, “at least one” means one or more, and “a plurality of” means two or more. “and/or” is used to describe an association relationship between an associated object, and it indicates that there may be three relationships. For example, “A and/or B” may represent three cases: there are only A, there are only B, and there are A and B, where A and B may be singular or plural. The character “/” generally indicates that the front and back associated objects are a “or” relationship. “At least one of the following” or a similar expression thereof, refers to any combination of these items, including any combination of a single item or plural items. For example, “at least one of a, b, or c” may represent: a, b, c, “a and b”, “a and c”, “b and c”, or “a and b and c”, where a, b, and c may be single or multiple.

It should also be noted that, herein, relational terms such as first and second, etc. are merely used to distinguish one entity or operation from another entity or operation without necessarily requiring or implying any such actual relationship or order between these entities or operations. Moreover, the terms “comprising,” “including,” or any other variation thereof are intended to cover a non-exclusive inclusion, such that a process, method, article, or device comprising a series of elements includes not only those elements, but also other elements not expressly listed, or elements inherent to such a process, method, article, or device. Without further restriction, elements defined by the statement “include one” do not preclude the presence of additional identical elements in the process, method, article, or device that includes the elements.

The steps of the methods or algorithms described in connection with the embodiments disclosed herein may be implemented directly in hardware, software modules executed by a processor, or a combination of the two. The software modules may be placed in a random-access memory (RAM), memory, read only memory (ROM), electrically programmable ROM, electrically erasable programmable ROM, register, hard disk, removable disk, CD-ROM, or any other form of storage medium known in the art.

The above description of the disclosed embodiments enables those skilled in the art to realize or use the present application. Various modifications to these embodiments will be apparent to those skilled in the art, and the general principles defined herein may be implemented in other embodiments without departing from the spirit or scope of the present application. Accordingly, the present application will not be limited to these embodiments shown herein but is to be accorded with the widest scope consistent with the principles and novel features disclosed herein.

What is claimed is:

1. A processing method, applied to an electronic device, the method comprising:
obtaining an application package of a target application for installation, wherein the application package comprises a native resource directory and a running resource directory, the native resource directory stores compression results of a plurality of resource packages in a target dimension, different resource packages are adapted to different configurations in the target dimension, and the running resource directory indicates an installed resource file;
obtaining a configuration parameter of the electronic device in the target dimension in response to a start request of the target application; and
decompressing and installing a compression result of a resource package adapted to the configuration parameter and updating the running resource directory in response to the running resource directory indicating that the resource package adapted to the configuration parameter is not installed and the compression result of the resource package adapted to the configuration parameter is stored in the native resource directory, the updated running resource directory indicating that the resource package adapted to the configuration parameter has been installed.

2. The method of claim 1, wherein the start request indicates starting the target application for the first time.

3. The method of claim 1, wherein the application package further comprises a supplementary resource directory, and the supplementary resource directory indicates a storage path of decompression results for respective compression results; and
decompressing and installing the compression result of the resource package adapted to the configuration parameter comprises:
decompressing the compression result of the resource package adapted to the configuration parameter to the supplementary resource directory for installation.

4. The method of claim 1, wherein a process of building the application package of the target application comprises:
dismantling a post file of the target application into a plurality of application packages, wherein the plurality of application packages comprise a basic package and the plurality of resource packages; and
building the application package of the target application based on the compression results of respective resource packages in the plurality of resource packages and the basic package, wherein the running resource directory in the application package of the target application indicates that an installation process of the application package of the target application comprises installing the basic package.

5. The method of claim 4, wherein the plurality of application packages further comprise one or more default resource packages in the target dimension, and a configuration adapted to the default resource package in the target dimension is different from a configuration adapted to respective resource packages of the plurality of resource packages in the target dimension; and
building the application package of the target application based on the compression results of respective resource packages in the plurality of resource packages and the basic package comprises:
building the application package of the target application based on the compression results of respective resource packages in the plurality of resource packages, the default resource package and the basic package, wherein the running resource directory in the application package of the target application indicates that the installation process of the application package of the target application further comprises installing the default resource package.

6. The method of claim 5, wherein a number of the default resource packages is determined based on at least one of: a size constraint of the application package of the target application or a running constraint of the target application on the electronic device, wherein:
the size constraint indicates a maximum size of the application package of the target application, and the running constraint indicates at least one of: a maximum time consumption or a maximum success rate of running the target application according to the configuration parameter of the electronic device in the target dimension.

7. The method of claim 4, wherein a compression algorithm for respective resource packages of the plurality of resource packages is determined based on at least one of: a size of the post file, a size constraint of the application package of the target application, or a running constraint of the target application on the electronic device, wherein:
the size constraint indicates a maximum size of the application package of the target application, and the running constraint indicates at least one of: a maximum time consumption or a maximum success rate of running the target application according to the configuration parameter of the electronic device in the target dimension.

8. The method of claim 1, further comprising:
loading the resource package adapted to the configuration parameter in response to the running resource directory indicating that the resource package adapted to the configuration parameter has been installed.

9. The method of claim 1, further comprising:
obtaining, from a server, the resource package adapted to the configuration parameter for installation in response to the running resource directory indicating that the resource package adapted to the configuration parameter is not installed and the compression result of the resource package adapted to the configuration parameter is not stored in the native resource directory, wherein the server provides at least one resource package in the target dimension to the target application, and a usage probability of a resource package obtained from the server is less than a usage probability of a resource package obtained from the native resource directory.

10. The method of claim 1, further comprising:
obtaining a target configuration indicated by a configuration switching request in response to the configuration switching request in the target dimension; and
in response to the running resource directory indicating that a resource package adapted to the target configuration is not installed and a compression result of the resource package adapted to the target configuration is stored in the native resource directory,
decompressing the compression result of the resource package adapted to the target configuration;
restarting the target application;
installing the resource package adapted to the target configuration obtained through decompression; and
updating the running resource directory, the updated running resource directory indicating that the resource package adapted to the target configuration has been installed.

11. The method of claim 1, wherein the target dimension comprises a language type.

12. An electronic device, comprising: at least one processor and at least one memory,
wherein the at least one memory is configured to store instructions or a computer program, and the at least one processor is configured to execute the instructions or the computer program in the at least one memory to cause the electronic device to perform operations comprising:
obtaining an application package of a target application for installation, wherein the application package comprises a native resource directory and a running resource directory, the native resource directory stores compression results of a plurality of resource packages in a target dimension, different resource packages are adapted to different configurations in the target dimension, and the running resource directory indicates an installed resource file;
obtaining a configuration parameter of the electronic device in the target dimension in response to a start request of the target application; and
decompressing and installing a compression result of a resource package adapted to the configuration parameter and updating the running resource directory in response to the running resource directory indicating that the resource package adapted to the configuration parameter is not installed and the compression result of the resource package adapted to the configuration parameter is stored in the native resource directory, the updated running resource directory indicating that the resource package adapted to the configuration parameter has been installed.

13. The electronic device of claim 12, wherein the start request indicates starting the target application for the first time.

14. The electronic device of claim 12, wherein the application package further comprises a supplementary resource directory, and the supplementary resource directory indicates a storage path of decompression results for respective compression results; and
decompressing and installing the compression result of the resource package adapted to the configuration parameter comprises:
decompressing the compression result of the resource package adapted to the configuration parameter to the supplementary resource directory for installation.

15. The electronic device of claim 12, wherein a process of building the application package of the target application comprises:
dismantling a post file of the target application into a plurality of application packages, wherein the plurality of application packages comprise a basic package and the plurality of resource packages; and
building the application package of the target application based on the compression results of respective resource packages in the plurality of resource packages and the basic package, wherein the running resource directory in the application package of the target application indicates that an installation process of the application package of the target application comprises installing the basic package.

16. The electronic device of claim 12, wherein the operations further comprise:
loading the resource package adapted to the configuration parameter in response to the running resource directory indicating that the resource package adapted to the configuration parameter has been installed.

17. The electronic device of claim 12, wherein the operations further comprise:
obtaining, from a server, the resource package adapted to the configuration parameter for installation in response to the running resource directory indicating that the resource package adapted to the configuration parameter is not installed and the compression result of the resource package adapted to the configuration parameter is not stored in the native resource directory, wherein the server provides at least one resource package in the target dimension to the target application, and a usage probability of a resource package obtained from the server is less than a usage probability of a resource package obtained from the native resource directory.

18. The electronic device of claim 12, wherein the operations further comprise:
obtaining a target configuration indicated by a configuration switching request in response to the configuration switching request in the target dimension; and
in response to the running resource directory indicating that a resource package adapted to the target configuration is not installed and a compression result of the resource package adapted to the target configuration is stored in the native resource directory,
decompressing the compression result of the resource package adapted to the target configuration;
restarting the target application;
installing the resource package adapted to the target configuration obtained through decompression; and
updating the running resource directory, the updated running resource directory indicating that the resource package adapted to the target configuration has been installed.

19. The electronic device of claim 12, wherein the target dimension comprises a language type.

20. A non-transitory computer readable medium, wherein the computer readable medium stores instructions or a computer program, and when the instructions or the computer program runs on a device, the device is caused to perform operations comprising:
obtaining an application package of a target application for installation, wherein the application package comprises a native resource directory and a running resource directory, the native resource directory stores compression results of a plurality of resource packages in a target dimension, different resource packages are adapted to different configurations in the target dimension, and the running resource directory indicates an installed resource file;
obtaining a configuration parameter of the device in the target dimension in response to a start request of the target application; and
decompressing and installing a compression result of a resource package adapted to the configuration parameter and updating the running resource directory in response to the running resource directory indicating that the resource package adapted to the configuration parameter is not installed and the compression result of the resource package adapted to the configuration parameter is stored in the native resource directory, the updated running resource directory indicating that the resource package adapted to the configuration parameter has been installed.
